(19) United States
(12) Patent Application Publication
(10) Pub. No.: US 2023/0223658 A1
(43) Pub. Date: Jul. 13, 2023

(54) LITHIUM-ION CELL WITH A HIGH SPECIFIC ENERGY DENSITY

(71) Applicant: VARTA Microbattery GmbH, Ellwangen Jagst (DE)

(72) Inventors: Edward Pytlik, Ellwangen (DE); David Ensling, Ellwangen (DE)

(21) Appl. No.: 18/002,057

(22) PCT Filed: Jun. 18, 2021
(86) PCT No.: PCT/EP2021/066609

§ 371 Date: Dec. 16, 2022

(30) Foreign Application Priority Data
Jun. 19, 2020 (EP) 20181273.2

(51) Int. Cl. H01M 50/489; H01M 10/0525; H01M 50/533; H01M 50/107; H01M 50/538; H01M 50/449; H01M 50/434

(52) U.S. Cl. CPC H01M 50/489; H01M 10/0525; H01M 50/533; H01M 50/107; H01M 50/538; H01M 50/449; H01M 50/434

(57) ABSTRACT

A lithium-ion cell includes a ribbon-shaped electrode-separator assembly having an anode, a cathode, and a separator. The electrode-separator assembly is in the form of a winding with two terminal end faces. The anode has a ribbon-shaped anode current collector with a free edge strip extending along a first longitudinal edge that is not loaded with negative electrode material. The cathode has a ribbon-shaped cathode current collector with a free edge strip extending along a first longitudinal edge that is not loaded with positive electrode material. The separator has at least one inorganic material that improves its resistance to thermal stress. The lithium-ion cell further includes a housing enclosing the electrode-separator assembly and a metallic contact element. The metallic contact element is connected to a respective first longitudinal edge of one of the current collectors by a weld.

### CROSS REFERENCE TO RELATED APPLICATIONS

This application is a U.S. National Phase application under 35 U.S.C. § 371 of International Application No. PCT/EP2021/066609, filed on Jun. 18, 2021, and claims benefit to European Patent Application No. EP 20181273.2, filed on Jun. 19, 2020. The International Application was published in German on Dec. 23, 2021 as WO 2021/255238 under PCT Article 21(2).

### FIELD

The disclosure relates to a lithium-ion cell comprising an electrode-separator assembly.

### BACKGROUND

Electrochemical cells can convert stored chemical energy into electrical energy by virtue of a redox-reaction. They generally comprise a positive and a negative electrode separated by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is enabled by an ion-conducting electrolyte.

If the discharge is reversible, i.e. there is the possibility of reversing the conversion of chemical energy to electrical energy that took place during the discharge, and thus of recharging the cell, the cell is called a secondary cell. The designation of the negative electrode as the anode and of the positive electrode as the cathode, which is customary in secondary cells, refers to the discharge function of the electrochemical cell.

The widely used secondary lithium-ion cells are based on the use of lithium, which can migrate back and forth between the electrodes of the cell in the form of ions. Lithium-ion cells are characterized by a comparatively high energy density. The negative electrode and the positive electrode of a lithium-ion cell are generally formed by so-called composite electrodes, which comprise electrochemically active components as well as electrochemically inactive components.

In principle, all materials that can absorb and release lithium ions can be used as electrochemically active components (active materials) for secondary lithium-ion cells. Carbon-based particles, such as graphitic carbon, are often used for the negative electrode. Other, non-graphitic carbon materials that are suitable for the intercalation of lithium can also be used. In addition, metallic and semi-metallic materials that are alloyable with lithium can also be used. For example, the elements tin, aluminum, antimony and silicon can form intermetallic phases with lithium. For example, lithium cobalt oxide (LiCoO₂), lithium manganese oxide (LiMn₂O₄), lithium iron phosphate (LiFePO₄) or derivatives thereof can be used as active materials for the positive electrode. The electrochemically active materials are generally contained in particle form in the electrodes.

As electrochemically inactive components, the composite electrodes generally comprise a flat and/or strip-shaped current collector, for example a metallic foil, coated with an active material. For example, the current collector for the negative electrode (anode current collector) may be formed of copper or nickel, and the current collector for the positive electrode (cathode current collector) may be formed of aluminum, for example. Furthermore, the electrodes can comprise an electrode binder (e.g. polyvinylidene fluoride (PVDF) or another polymer, for example carboxymethyl cellulose). This ensures the mechanical stability of the electrodes and often the adhesion of the active material to the current collectors. Furthermore, the electrodes may contain conductivity-improving additives and other additives.

As electrolytes, lithium-ion cells generally comprise solutions of lithium salts such as lithium hexafluorophosphate (LiPF₆) in organic solvents (e.g., ethers and esters of carbonic acid).

During the manufacture of a lithium-ion cell, the composite electrodes are combined with one or more separators to form an assembly. In this process, the electrodes and separators are usually joined together under pressure, if necessary also by lamination or by bonding. The basic functionality of the cell can then be established by impregnating the assembly with the electrolyte.

In many embodiments, the assembly is formed flat so that multiple assemblies can be stacked flat on top of each other. Frequently, however, the assembly is produced as a winding or processed into a winding.

Generally, the assembly, whether wound or not, comprises the sequence positive electrode/separator/negative electrode. Often, assemblies are manufactured as so-called bi-cells with the possible sequences negative electrode/separator/positive electrode/separator/negative electrode or positive electrode/separator/negative electrode/separator/positive electrode.

For applications in the automotive sector, for e-bikes or also for other applications with high energy requirements such as in tools, lithium-ion cells with the highest possible energy density are needed that can simultaneously be loaded with high currents during charging and discharging.

Cells for the applications mentioned are often designed as cylindrical round cells, for example with the form factor 21×70 (diameter*height in mm). Cells of this type always comprise an assembly in the form of a winding. Modern lithium-ion cells of this form factor can already achieve an energy density of up to 270 Wh/kg. However, this energy density is only considered an intermediate step. The market is already demanding cells with even higher energy densities.

However, there are other factors to consider in the development of improved lithium-ion cells than just energy density. Extremely important parameters are also the internal resistance of the cells, which should be kept as low as possible to reduce power losses during charging and discharging, and the thermal connection of the electrodes, which can be essential for temperature regulation of the cell. These parameters are also very important for cylindrical round cells that contain a composite assembly in the form of a winding. During fast charging of cells, heat accumulation can occur in the cells due to power losses, which can lead to massive thermomechanical stress and subsequently to deformation and damage of the cell structure. The risk is amplified when the electrical connection of the current collectors is made via separate electrical conductor tabs welded to the current collectors, which protrude axially from wound assemblies, as heating can occur locally at these conductor tabs under heavy loads during charging or discharging.

WO 2017/215900 A1 describes cells in which the electrode-separator assembly and its electrodes are ribbon-shaped and are in the form of a winding. The electrodes each have current collectors loaded with electrode material. Oppositely poled electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has at least one contact plate which rests on one of the longitudinal edges in such a way that a line-shaped contact zone is formed. The contact plate is connected to the longitudinal edge along the line-shaped contact zone by welding. This makes it possible to electrically contact the current collector and thus also the associated electrode over his/her entire length. This significantly reduces the internal resistance within the cell described. The occurrence of large currents can subsequently be absorbed much better.

However, a problem with the cells described in WO 2017/215900 A1 is that it is very difficult to weld the longitudinal edges and the contact plates together. In relation to the contact plates, the current collectors of the electrodes have a very small thickness. The edge area of the current collectors is therefore mechanically extremely sensitive and can be inadvertently depressed or melted down during the welding process. Furthermore, separators of the electrode-separator assembly may melt when the contact plates are welded on. In extreme cases, this can result in short circuits.

### SUMMARY

In an embodiment, the present disclosure provides a lithium-ion cell. The lithium-ion cell includes a ribbon-shaped electrode-separator assembly comprising an anode, a cathode, and a separator in a sequence anode/separator/cathode. The electrode-separator assembly is in the form of a winding with two terminal end faces. The anode comprises a negative electrode material and a ribbon-shaped anode current collector having a first longitudinal edge, a second longitudinal edge, and two ends. A strip-shaped main region of the anode current collector is loaded with a layer of the negative electrode material and a free edge strip of the anode current collector, extending along the first longitudinal edge, is not loaded with the negative electrode material. The cathode comprises a positive electrode material and a ribbon-shaped cathode current collector having a first longitudinal edge, a second longitudinal edge, and two ends. A strip-shaped main region of the cathode current collector is loaded with a layer of the positive electrode material and a free edge strip of the cathode current collector, extending along the first longitudinal edge, is not loaded with the positive electrode material. The separator comprises at least one inorganic material that improves its resistance to thermal stress. The lithium-ion cell further includes a housing enclosing the electrode-separator assembly and a metallic contact element. The anode and the cathode are offset within the electrode-separator assembly so that the first longitudinal edge of the anode current collector protrudes from a first terminal end face of the terminal faces and the first longitudinal edge of the cathode current collector protrudes from a second terminal end face of the terminal faces. A respective first longitudinal edge is in direct contact with the metallic contact element, the respective first longitudinal edge being the first longitudinal edge of the anode current collector or the first longitudinal edge of the cathode current collector. The metallic contact element is connected to the respective first longitudinal edge by a weld.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a top view of a current collector in an embodiment;

FIG. 2 a sectional view of the current collector shown in FIG. 1;

FIG. 3 a top view of an anode that can be processed into an electrode-separator assembly in the form of a winding;

FIG. 4 a sectional view of the anode shown in FIG. 3;

FIG. 5 a top view of an electrode-separator assembly fabricated using the anode shown in FIG. 3;

FIG. 6 a sectional view of the electrode-separator assembly shown in FIG. 5;

FIG. 7 a sectional view of an embodiment of a cell in the form of a cylindrical round cell;

FIG. 8 a sectional view of a further embodiment of a cell in the form of a cylindrical round cell;

FIG. 9 a sectional view of a further embodiment of a cell in the form of a cylindrical round cell;

FIG. 10 a sectional view of a further embodiment of a cell in the form of a cylindrical round cell;

FIG. 11 a sectional view of a further embodiment of a cell in the form of a cylindrical round cell; and

FIG. 12 an illustration of a method of manufacturing the cell which is shown in FIG. 11.

### DETAILED DESCRIPTION

The present disclosure provides lithium-ion cells which are characterized by an improved energy density compared to the prior art as well as a homogeneous current distribution as far as possible over the entire area and length of their electrodes and which at the same time have excellent characteristics with regard to their internal resistance and their passive heat dissipation capabilities. Furthermore, the cells should also be characterized by improved manufacturability and safety.

According to a first aspect, the disclosure provides a lithium-ion cell characterized by the following features a. to j.:

a. The cell comprises an electrode-separator assembly having the sequence anode/separator/cathode, preferably a ribbon-shaped electrode-separator assembly having the sequence anode/separator/cathode.

b. The anode comprises a negative electrode material and an anode current collector having first and second longitudinal edges and two ends.

c. The anode current collector has a main region loaded with a layer of the negative electrode material, preferably a strip-shaped main region loaded with a layer of the negative electrode material, and a free edge strip which extends along the first longitudinal edge of the anode current collector and which is not loaded with the electrode material.

d. The cathode comprises a positive electrode material and a cathode current collector having first and second longitudinal edges and two ends.

e. The cathode current collector has a main region loaded with a layer of the positive electrode material, preferably a strip-shaped main region loaded with a layer of the positive electrode material, and a free edge strip which extends along the first longitudinal edge of the cathode current collector and which is not loaded with the electrode material.

f. The electrode-separator assembly is in the form of a winding with two terminal end faces.

g. The electrode-separator assembly is enclosed in a housing.

h. The anode and cathode are offset within the electrode-separator assembly so that the first longitudinal edge of the anode current collector protrudes from one of the terminal end faces and the first longitudinal edge of the cathode current collector protrudes from the other of the terminal end faces.

i. The cell has a metallic contact element arranged parallel to the end face, in particular a metallic contact plate, which is in direct contact with one of the first longitudinal edges, preferably longitudinally.

j. The contact element, in particular the metallic contact plate, is connected to this longitudinal edge by welding.

Preferably, the cell comprises two contact elements, in particular two metallic contact plates, one of which is in direct contact with the first longitudinal edge of the anode current collector and the other of which is in direct contact with the first longitudinal edge of the cathode current collector, wherein the contact elements and the longitudinal edges in contact therewith are each being connected to one another by welding.

The current collectors have the function of electrically contacting electrochemically active components contained in the electrode material over an area as large as possible. Preferably, the current collectors are made of a metal or are at least metallized on the surface. Suitable metals for the anode current collector include copper or nickel or other electrically conductive materials, in particular copper and nickel alloys or nickel-coated metals. Stainless steel is also generally a possibility. Suitable metals for the cathode current collector include aluminum or other electrically conductive materials, in particular aluminum alloys.

Preferably, the anode current collector and/or the cathode current collector is each a metal foil having a thickness in the range of 4 μm to 30 μm, in particular a ribbon-shaped metal foil having a thickness in the range of 4 μm to 30 μm.

In addition to foils, however, other strip-shaped substrates such as metallic or metallized nonwovens or open-cell foams or expanded metals can be used as current collectors.

The current collectors are preferably loaded on both sides with the respective electrode material.

In the free edge strips, the metal of the respective current collector is free of the respective electrode material. Preferably, the metal of the respective current collector is uncovered there so that it is available for electrical contacting, for example by welding.

According to developments, the lithium-ion cell is a secondary lithium-ion cell.

Basically all electrode materials known for secondary lithium-ion cells can be used for the anode and cathode of the cell.

Carbon-based particles such as graphitic carbon or non-graphitic carbon materials, preferably also in particle form, which are capable of intercalating lithium, can be used as active materials in the negative electrode. Alternatively or additionally, lithium titanate (Li₄Ti₅O₁₂) or a derivative thereof may be included in the negative electrode, preferably also in particle form.

In a development, the cell has the immediately following feature k.:

k. The separator comprises at least one inorganic material that improves its resistance to thermal stress.

This material protects the separator from shrinkage as a result of local heating, which can occur in particular when the contact elements, especially the contact plates, are welded on. The risk of a short circuit is thus considerably reduced.

In a preferred further development, the cell has at least one of the immediately following features a. to c.:

a. The electrode-separator assembly comprises a first separator and a second separator.

b. The first separator and the second separator are identical.

c. The electrode-separator assembly has the sequence anode/first separator/cathode/second separator or the sequence first separator/anode/second separator/cathode.

It is preferred that the immediately preceding features a. and c., and optionally also the immediately preceding features a. to c. are implemented in combination with one another.

Preferably, both the first and second separators are improved against thermal stress by means of the at least one inorganic material.

In further possible preferred developments, the cell has at least one of the immediately following features a. or b:

a. The first and/or the second separator is an electrically insulating sheet, for example a foil or a fabric or a nonwoven, in particular made of at least one plastic, with a thickness in the range from 5 μm to 50 μm, preferably in the range from 10 μm to 30 μm.

b. The edges of the first and/or the second separator, in particular the longitudinal edges of the first and/or the second separator, form the end faces of the electrode-separator assembly.

It is preferred that the immediately preceding features a. and b. are realized in combination with each other.

The above information regarding the preferred thickness of the separators refers to the separators including the inorganic material.

It is preferred that the longitudinal edges of the anode current collector and/or the cathode current collector protruding from the terminal end faces of the winding do not exceed 5000 μm, preferably not exceed 3500 μm, from the end faces or the sides.

Particularly preferably, the longitudinal edge of the anode current collector protrudes from the end face of the winding no more than 2500 μm, especially preferably no more than 1500 μm. Particularly preferably, the longitudinal edge of the cathode current collector protrudes from the end face of the winding no more than 3500 μm, especially preferably no more than 2500 μm.

The figures for the projection of the anode current collector and/or the cathode current collector refer to the free projection before the sides or end faces are brought into contact with the contact element, in particular the contact plate. When welding on the contact element, in particular the contact plate, deformation of the edges of the current collectors may occur.

The smaller the free projection is selected, the wider the preferably strip-shaped main regions of the current collectors covered with electrode material can be formed. This can contribute positively to the energy density of the cell.

If the electrode-separator assembly is in the form of a winding with two terminal end faces, it is preferred that the separator be ribbon-shaped, in particular having a first and a second longitudinal edge and two end faces.

In a preferred further development, the cell has the immediately following feature a.:

a. The at least one inorganic material is contained as particulate filler material in the separator, in particular the first separator and/or the second separator.

The separator can therefore preferably be an electrically insulating plastic film in which the particulate filler material is embedded. It is preferred that the plastic film can be penetrated by the electrolyte, for example because it has micropores. The foil may, for example, be formed from a polyolefin or from a polyetherketone. It is not excluded that nonwovens and fabrics made of such plastic materials can also be used.

The proportion of the particulate filler material in the separator is preferably at least 40% by weight, preferably at least 60% by weight.

In further preferred developments, the cell has the immediately following feature a. below:

a. The at least one inorganic material is present as a coating on a surface of the separator, in particular the first separator and/or the second separator.

The separator can therefore preferably also be a plastic film or a nonwoven or a fabric or other electrically insulating sheet material coated with the particulate filler material.

In this case, separators are preferably used which have a base thickness in the range from 5 μm to 20 μm, preferably in the range from 7 μm to 12 μm. The total thickness of the separators results from the base thickness and the thickness of the coating.

In some embodiments, only one side of the sheet-like structure, in particular the plastic film, is coated with the inorganic material. In further embodiments, the sheet-like structure, in particular the plastic film, is preferably coated on both sides with the inorganic material.

The thickness of the coating is preferably in the range from 0.5 μm to 5 μm. It follows from this that the total thickness of the separators in the case of a double-sided coating is preferably in the range from 6 μm to 30 μm, preferably in the range from 8 μm to 22 μm. In the case of a single-sided coating, the thickness is preferably in the range from 5.5 μm to 20.5 μm, preferably in the range from 7.5 μm to 17 μm.

Where appropriate, it may also be preferred that the separators used comprise an inorganic material as a filler and the same or a different inorganic material as a coating.

In further possible preferred developments, the cell has at least one of the immediately following features a. to e:

a. The at least one inorganic material is or comprises an electrically insulating material.

b. The at least one inorganic material is or comprises at least one material selected from the group consisting of ceramic material, glass-ceramic material, and glass.

c. The at least one inorganic material is or comprises a lithium ion conductive ceramic material, for example Li₅AlO₄*Li₄SiO₄ or LiAlSi₂O₆.

d. The at least one inorganic material is or comprises an oxidic material, in particular a metal oxide.

e. The ceramic or oxide material is aluminum oxide (Al₂O₃), titanium oxide (TiO₂), titanium nitride (TiN), titanium aluminum nitride (TiAlN), a silicon oxide, especially silicon dioxide (SiO₂), or titanium carbonitride (TiCN).

It is preferred that the immediately preceding features a. to c. or the immediately preceding features a. and b. and d. or the immediately preceding features a. and b. and e. are realized in combination with each other.

Among the aforementioned materials, aluminum oxide (Al₂O₃), titanium oxide (TiO₂) and silicon dioxide (SiO₂) are preferred as coating materials.

In further possible preferred developments, the cell has at least one of the immediately following features a. to c.:

a. The first separator and/or the second separator comprises the at least one inorganic material only in regions.

b. The first separator and/or the second separator has an edge strip along the first and/or the second longitudinal edge in which it comprises the at least one inorganic material as a coating and/or as a particulate filler material.

c. The first separator and/or the second separator has a preferably ribbon-shaped main region in which it is free of the at least one inorganic material.

It is preferred that the immediately preceding features a. to c. are realized in combination with each other.

It is by no means essential that the separator comprises the inorganic material in homogeneous distribution or is uniformly coated with the material everywhere. Rather, it may even be preferred that the separator is free of the inorganic material in certain regions, for example in said main region. In this region, elevation of the thermal resistance of the separator is not needed as much as at the edges of the separator. In addition, the inorganic material may contribute to an unwanted elevation of the internal resistance of the cell, especially in this region.

### Protection of the Edges of the Current Collectors

In some embodiments, the metal of the respective current collector in the free edge strips may be coated with a support material that is more thermally resistant than the current collector coated therewith and that is different from the electrode material disposed on the respective current collector.

“Thermally more resistant” in this context is intended to mean that the support material retains a solid state at a temperature at which the metal of the current collector melts. It therefore either has a higher melting point than the metal or it sublimates or decomposes only at a temperature at which the metal has already melted.

Preferably, both the anode current collector and the cathode current collector each have a free edge strip along the first longitudinal edge that is not loaded with the respective electrode material. In a further development, it is preferred that both the at least one free edge strip of the anode current collector and the at least one free edge strip of the cathode current collector are coated with the support material. Particularly preferably, the same support material is used for each of the regions.

The support material which can be used in the context of the present disclosure can in principle be a metal or a metal alloy, provided that it has a higher melting point than the metal from which the surface coated with the support material consists of. In many embodiments, however, the lithium-ion cell preferably has at least one of the immediately following additional features a. to d.:

a. The support material is a non-metallic material.

b. The support material is an electrically insulating material.

c. The non-metallic material is a ceramic material, a glass-ceramic material or a glass.

d. The ceramic material is aluminum oxide (Al₂O₃), titanium oxide (TiO₂), titanium nitride (TiN), titanium aluminum nitride (TiAlN), a silicon oxide, in particular silicon dioxide (SiO₂), or titanium carbonitride (TiCN).

The support material can be characterized according to the immediately preceding feature b. and especially preferably according to the immediately preceding feature d.

The term non-metallic material comprises in particular plastics, glasses and ceramic materials.

The term “electrically insulating material” is to be understood broadly in this context. In principle, it comprises any electrically insulating material, in particular also said plastics.

The term ceramic material is to be understood broadly in this context. In particular, this includes carbides, nitrides, oxides, silicides or mixtures and derivatives of these compounds.

By the term “glass-ceramic material” is meant in particular a material comprising crystalline particles embedded in an amorphous glass phase.

The term “glass” basically means any inorganic glass that meets the thermal stability criteria defined above and that is chemically stable to any electrolyte that may be present in the cell.

Particularly preferably, the anode current collector consists of copper or a copper alloy while at the same time the cathode current collector consists of aluminum or an aluminum alloy and the support material is aluminum oxide or titanium oxide.

It may be further preferred that free edge strips of the anode and/or cathode current collector are coated with a strip of the support material.

The strip-shaped main regions, in particular the strip-shaped main regions of the anode current collector and cathode current collector, preferably extend parallel to the respective longitudinal edges of the current collectors. Preferably, the strip-shaped main regions extend over at least 90%, preferably over at least 95%, of the areas of the anode current collector and cathode current collector.

In some preferred embodiments, the support material is applied immediately adjacent to the preferably strip-shaped main regions, but does not completely cover the free regions in the process. For example, it is applied in the form of a strip or line along a longitudinal edge of the anode and/or cathode current collector so that it only partially covers the respective edge strip. Directly along this longitudinal edge, an elongated section of the free edge strip can remain uncovered.

Accordingly, in an embodiment the cell is characterized by at least one of the immediately following features a. to c.:

a. The free edge strip of the anode current collector and/or the free edge strip of the cathode current collector comprises a first sub-region and a second sub-region, wherein the first sub-region is coated with the support material while the second sub-region is uncoated.

b. The first sub-region and the second sub-region each have the shape of a line or a strip and run parallel to each other.

c. The first sub-region is located between the strip-shaped main region of the anode current collector or the cathode current collector and the second sub-region.

It is preferred that the immediately preceding features a. to c. are realized in combination with each other.

In an alternative embodiment, the cell is characterized by the immediately following feature a.:

a. The free edge strip of the anode current collector and/or the free edge strip of the cathode current collector is coated with the support material up to the first longitudinal edge.

In an embodiment the cell is characterized by a combination of the immediately following features a. and b.:

a. The separator comprises the at least one inorganic material only in sub-regions.

b. The separator comprises the at least one inorganic material in a region that covers a boundary between the support material and the respective adjacent electrode material in the electrode-separator assembly.

### Preferred Embodiments of the Electrode Materials and Electrolyte.

In some preferred embodiments, the cell has the immediately following feature a.:

a. The negative electrode material comprises as active material at least one material selected from the group consisting of silicon, aluminum, tin, antimony, and a compound or alloy of these materials capable of reversibly intercalating and deintercalating lithium, in an amount of from 20 wt % to 90 wt %.

The weights given here refer to the dry mass of the negative electrode material, i.e. without electrolyte and without taking into account the weight of the anode current collector.

Tin, aluminum, antimony and silicon can form intermetallic phases with lithium. The capacity to absorb lithium exceeds that of graphite or comparable materials many times over, especially in the case of silicon.

Among the active materials mentioned, which are preferably also used in the form of particles, silicon is preferred. According to embodiments, the negative electrode contains silicon as active material in a proportion of 20 wt. % to 90 wt. %.

Also, some compounds of silicon, aluminum, tin, and/or antimony can reversibly incorporate and release lithium. For example, in some preferred embodiments, the silicon may be present in oxidic form in the negative electrode. In these embodiments, it may be preferred that the negative electrode comprise silicon oxide in an amount ranging from 20 wt % to 90 wt %.

The design of the cell enables a significant advantage. As mentioned at the outset, electrodes in which the electrical connection of the current collectors is made via the separate conductor tabs mentioned at the outset experience greater thermomechanical stress during charging and discharging immediately in the vicinity of the conductor tabs than away from the conductor tabs. This difference is pronounced in the case of negative electrodes containing silicon, aluminum, tin and/or antimony as active material.

The electrical connection of the current collectors via contact elements, in particular contact plates, not only enables comparatively uniform and efficient heat dissipation of cells, but also distributes the thermomechanical loads occurring during charging and discharging evenly over the winding. Surprisingly, this makes it possible to control very high proportions of silicon and/or tin and/or antimony in the negative electrode; at proportions >50%, comparatively rare or no damage occurs during charging and discharging as a result of the thermomechanical loads. By elevating the proportion of silicon, for example, in the anode, the energy density of the cell can be greatly increased.

The skilled person understands that the tin, aluminum, silicon and antimony do not necessarily have to be metals in their purest form. For example, silicon particles may also contain traces or proportions of other elements, in particular other metals (apart from the lithium contained in any case as a function of the state of charge), for example in proportions of up to 40% by weight, in particular in proportions of up to 10% by weight. Thus, alloys of tin, aluminum, silicon and antimony can also be used.

In embodiments, the cell has at least one of the immediately following features a. and b:

a. The negative electrode material further comprises, as the negative active material, carbon-based particles capable of reversible incorporation and release of lithium, such as graphitic carbon, in particular a mixture of the silicon and these carbon-based particles.

b. The carbon-based particles capable of intercalating lithium are present in the electrode material in a proportion of from 5 wt. % to 75 wt. %, in particular in a proportion of from 15 wt. % to 45 wt. %.

In further embodiments, the cell has at least one of the immediately following features a. to c.:

a. The negative electrode material comprises an electrode binder and/or a conductive agent.

b. The electrode binder is present in the negative electrode material in a proportion of 1 wt. % to 15 wt. %, in particular in a proportion of 1 wt. % to 5 wt. %.

c. The conductive agent is present in the negative electrode material in a proportion of 0.1 wt. % to 15 wt. %, in particular in a proportion of 1 wt. % to 5 wt. %.

It is preferred that the immediately preceding features a. to c. are realized in combination with each other.

The active materials are preferably embedded in a matrix of the electrode binder, with adjacent particles in the matrix preferably being in direct contact with each other.

Conductive agents have the function of elevating the electrical conductivity of the electrodes. Common electrode binders are based on polyvinylidene fluoride (PVDF), polyacrylate or carboxymethyl cellulose, for example. Common conductive agents are carbon black and metal powder.

In the context of the present disclosure, it is preferred that the positive electrode material comprises a PVDF binder and the negative electrode material comprises a polyacrylate binder, in particular lithium polyacrylic acid.

Suitable active materials for the positive electrode include lithium metal oxide compounds and lithium metal phosphate compounds such as LiCoO₂ and LiFePO₄. Furthermore, lithium nickel manganese cobalt oxide (NMC) with the chemical formula LiNiₓMn_{y}Co_{z}O₂ (where x+y+z is typically 1) is particularly well suited, Lithium manganese spinel (LMO) with the chemical formula LiMn₂O₄, or lithium nickel cobalt alumina (NCA) with the chemical formula LiNiₓCo_{y}Al_{z}O₂ (where x+y+z is typically 1). Derivatives thereof, for example lithium nickel manganese cobalt alumina (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of said materials can also be used.

The high silicon content in the anode of a cell requires a correspondingly high-capacity cathode in order to achieve a good cell balance. Therefore, NMC, NCA or NMCA are preferred.

In embodiments, the cell has at least one of the immediately following features a. to e:

a. The positive electrode material comprises as active material at least one metal oxide compound capable of reversible lithium intercalation and deintercalation, preferably one of the above compounds, in particular NMC, NCA or NMCA.

b. The at least one oxidic compound is present in the electrode material in a proportion of from 50% by weight to 99% by weight, in particular in a proportion of from 80% by weight to 99% by weight.

c. The positive electrode material also preferably comprises the electrode binder and/or the conductive agent.

d. The electrode binder is present in the positive electrode material in a proportion of 0.5 wt. % to 15 wt. %, preferably in a proportion of 1 wt. % to 10 wt. %, especially in a proportion of 1 wt. % to 2 wt. %.

e. The conductive agent is contained in the positive electrode material in a proportion of 0.1 wt. % to 15 wt. %.

It is preferred that the immediately preceding features a. to e. are realized in combination with each other.

In the case of both the positive and negative electrodes, it is preferred that the percentages of each component contained in the electrode material add up to 100% by weight.

While high-capacity cathodes can store lithium reversibly in the range of 200-250 mAh/g, the theoretical capacity of silicon is approx. 3500 mAh/g. This leads to comparatively thick cathodes with high surface charge and very thin anodes with low surface charge. Since materials such as silicon react strongly to small voltage changes due to their very high capacitance, the anode current collector should be coated as homogeneously as possible. Even small differences in the loading of the current collector and/or the densification of the electrode material can lead to strong local deviations in the electrode balance and/or stability.

For this reason, in preferred embodiments, the cell has the immediately following feature a.:

a. The weight per unit area of the negative electrode of at least 10 cm² deviates from an average value by a maximum of 2%.

The mean value is the quotient of the sum of at least 10 measurement results divided by the number of measurements performed.

Furthermore, the cell preferably comprises an electrolyte, for example based on at least one lithium salt such as lithium hexafluorophosphate (LiPF₆) dissolved in an organic solvent (e.g. in a mixture of organic carbonates or a cyclic ether such as THF or a nitrile). Other lithium salts that can be used include lithium tetrafluoroborate (LiBF₄), lithium bis(trifluoromethanesulfonyl)imide (LiTFSI), lithium bis(fluorosulfonyl)imide (LiFSI), and lithium bis(oxalato)borate (LiBOB).

In embodiments, the cell has at least one of the immediately following features a. to d.:

a. The cell comprises an electrolyte comprising a mixture of tetrahydrofuran (THF) and 2-methyltetrahydrofuran (mTHF).

b. The volume ratio of THF:to mTHF in the mixture is in the range of 2:1 to 1:2, preferably it is 1:1.

c. The cell comprises an electrolyte comprising LiPF₆ as a conducting salt.

d. The conducting salt in a proportion of 1 to 2.5 M, in particular in a proportion of 1 to 1.5 M, contained in the electrolyte.

In embodiments, the electrolyte of the cell can be characterized by all the above features a. to d.

In alternative embodiments, the cell has at least one of the immediately following features a. to e:

a. The cell comprises an electrolyte comprising a mixture of fluoroethylene carbonate (FEC) and ethyl methyl carbonate (EMC).

b. The volume ratio of FEC:to EMC in the mixture is in the range of 1:7 to 5:7, preferably it is 3:7.

c. The cell comprises an electrolyte comprising LiPF₆ as a conducting salt.

d. The conducting salt is present in the electrolyte at a concentration of 1.0 to 2.0 M, in particular 1.5 M.

e. The electrolyte comprises vinylene carbonate (VC), in particular in a proportion of 1 to 3% by weight.

In embodiments, the electrolyte of the cell is characterized by all the features a. to e. above.

To improve cycling stability, the ratio of the capacitances of the anode to the cathode of the cell is preferably balanced so that the potential capacitance of the silicon is not fully utilized.

Particularly preferably, the cell has the immediately following feature a:

a. The anode-to-cathode capacitances of the cell are balanced such that during operation per gram of electrode material of the negative electrode only 700-1500 mAh is reversibly used.

This measure allows volume changes to be significantly reduced.

It should be emphasized that all the described embodiments, in which the negative electrode material comprises as active material at least one material from the group comprising silicon, aluminum, tin, antimony and a compound or alloy of these materials which can reversibly incorporate and release lithium, can be realized completely independently of the separator comprising at least one inorganic material that improves its resistance to thermal stress. The invention thus also comprises cells in which the anode necessarily comprises a proportion of from 20% to 90% by weight of silicon, aluminum, tin and/or antimony as active material, but the separator need not necessarily comprise the at least one inorganic material that improves its resistance to thermal stress.

### Preferred Embodiments of the Contact Elements

The concept of welding the edges of current collectors with contact plates is already known from WO 2017/215900 A1 or JP 2004-119330 A. The use of contact plates enables high current carrying capacities and low internal resistance. With regard to methods for electrically connecting contact elements, in particular contact plates, to the edges of current collectors, full reference is therefore made to the contents of WO 2017/215900 A1 and JP 2004-119330 A.

In the simplest case, the contact elements are sheet metal parts designed to rest flat on the end faces of wound electrode-separator assemblies. This is important to ensure efficient welding.

As already explained above, the contact elements are preferably designed as contact plates, i.e. plate-shaped.

In some preferred embodiments, the cell has at least one of the immediately following features a. and b.:

a. Metal plates with a thickness in the range from 50 μm to 600 μm, preferably 150-350 μm, are used as contact elements, in particular as contact plates.

b. The contact elements, in particular the contact plates, consist of alloyed or unalloyed aluminum, titanium, nickel or copper, but also, if necessary, of stainless steel (for example of type 1.4303 or 1.4304) or nickel-plated steel.

In some embodiments, contact elements, in particular contact plates, may be used which have at least one slot and/or at least one perforation. These have the function of counteracting deformation of the plates during the production of the welded joint.

As will be discussed in more detail below, the housing in which the electrode-separator assembly is located may be cylindrical or prismatic.

In cases where the housing is cylindrical, contact elements, in particular contact plates, are preferably used which have the shape of a disk, in particular the shape of a circular or at least approximately circular disk. They then have an outer circular or at least approximately circular disk edge. In this context, an approximately circular disc is to be understood in particular as a disc which has the shape of a circle with at least one cut off circular segment, preferably with two to four cut off circular segments.

In cases where the housing is prismatic, contact elements, in particular contact plates, are preferably used which have a rectangular basic shape.

In simpler cases, the contact element may be a metal strip or have multiple strip-shaped segments, such as in a star-shaped arrangement.

In preferred embodiments, the anode current collector and the contact element welded thereto, in particular the contact plate welded thereto, both consist of the same material. This is particularly preferably selected from the group comprising copper, nickel, titanium, nickel-plated steel and stainless steel.

In further preferred embodiments, the cathode current collector and the contact element welded thereto, in particular the contact plate welded thereto, both consist of the same material. This is preferably selected from the group comprising alloyed or unalloyed aluminum, titanium and stainless steel (e.g. of type 1.4404).

As mentioned above, the cell has a metallic contact element, in particular a metallic contact plate, with which one of the first longitudinal edges, preferably longitudinally, is in direct contact with. This may result in a line-shaped contact zone.

In possible further preferred developments, the cell has at least one of the immediately following features a. to c.:

a. The first longitudinal edge of the anode current collector is in direct contact with a metallic contact element, in particular a metallic contact plate, preferably longitudinally, and is connected to this contact element, in particular this contact plate, by welding, wherein there is a line-shaped contact zone between the longitudinal edge and the metallic contact element, in particular the metallic contact plate.

b. The first longitudinal edge of the cathode current collector is in direct contact with a metallic contact element, in particular a metallic contact plate, preferably longitudinally, and is connected to this contact element, in particular this contact plate, by welding, wherein there is a line-shaped contact zone between the longitudinal edge and the metallic contact element, in particular the metallic contact plate.

c. The first longitudinal edge of the anode current collector and/or the first longitudinal edge of the cathode current collector comprises one or more sections, each of which is continuously connected to the respective contact element, in particular the respective contact plate, over its entire length via a weld seam.

The immediately preceding features a. and b. can be implemented both independently of each other and in combination. Preferably, however, features a. and b. are implemented in both cases in combination with the immediately preceding feature c.

Via the contact elements, it is possible to electrically contact the current collectors and thus also the associated electrodes, preferably over their entire length. This significantly reduces the internal resistance within the cell. The arrangement described can thus excellently absorb the occurrence of large currents. With minimized internal resistance, thermal losses at high currents are reduced. In addition, the dissipation of thermal energy from the electrode-separator assembly is favored.

There are several ways in which the contact elements can be connected to the longitudinal edges.

The contact elements can be connected to the longitudinal edges along the line-shaped contact zones via at least one weld seam. The longitudinal edges can thus comprise one or more sections, each of which is continuously connected to the contact element or elements, in particular contact plates, over its entire length via a weld seam. Particularly preferably, these sections have a minimum length of 5 mm, preferably of 10 mm, especially preferably of 20 mm.

In a further possible embodiment, the section or sections connected continuously to the contact element, in particular the contact plate, over their entire length extend over at least 25%, preferably over at least 50%, preferably over at least 75%, of the total length of the respective longitudinal edge.

In some preferred embodiments, the longitudinal edges are continuously welded to the contact element, particularly the contact plate, along their entire length.

In further possible embodiments, the contact elements are connected to the respective longitudinal edge via a plurality or plurality of welding spots.

If the electrode-separator assembly is in the form of a spiral winding, the longitudinal edges of the anode current collector and the cathode current collector protruding from the terminal end faces of the winding generally also have a spiral geometry. The same then applies to the line-shaped contact zone along which the contact elements, in particular the contact plates, are welded to the respective longitudinal edge.

### Preferred Embodiments of the Housing

In the manufacture of assemblies of electrodes and separators, care is usually taken to ensure that oppositely poled current collectors do not protrude from one side, as this can elevate the risk of short circuits. However, with the staggered arrangement of anode and cathode described above, the short-circuit hazard is minimized because the oppositely poled current collectors protrude from opposite end faces of the winding.

The protrusion of the current collectors resulting from the staggered arrangement can be utilized by contacting them by means of an appropriate diverter, preferably over their entire length. The aforementioned contact element serves as the diverter. Such electrical contacting significantly reduces the internal resistance within the cell. The arrangement described can thus absorb the occurrence of large currents very well. With minimized internal resistance, thermal losses at high currents are reduced. In addition, the dissipation of thermal energy from the wound electrode-separator assembly is favored. Under heavy loads, heating does not occur locally but is evenly distributed.

In addition to the elements mentioned, the lithium-ion cell can expediently also comprise a housing consisting of two or more housing parts, which preferably encloses the electrode-separator assembly in the form of a winding in a gas-tight and/or liquid-tight manner.

When using the contact elements, it is generally necessary to connect the contact elements electrically to the housing or to electrical conductors that are led out of the housing. For example, the contact elements can be connected to the housing parts mentioned directly or via electrical conductors for this purpose.

In embodiments, the cell is characterized in that a part of the housing serves as the contact element, in particular the contact plate, and/or in that the contact element, in particular the contact plate, forms part of the housing enclosing the electrode-separator assembly.

These embodiments are advantageous. On the one hand, it is optimal with regard to heat dissipation. Heat generated within the winding can be dissipated directly to the housing via the edges, in particular the longitudinal edges. Secondly, the internal volume of a housing with given external dimensions can be utilized almost optimally in this way. Each separate contact element and each separate electrical conductor for connecting the contact elements to the housing requires space inside the housing and contributes to the weight of the cell. By eliminating such separate components, this space is available for active material. Thus, the energy density of cells can be further elevated.

In a first, contacting variant, the cell has at least one of the immediately following features a. and b., preferably a combination of the two features:

a. The housing comprises a cup-shaped first housing part having a bottom and a circumferential side wall and an opening, and a second housing part closing the opening.

b. The contact element, in particular the contact plate, is the bottom of the first housing part.

Preferably, the housing is cylindrical or prismatic in shape. Accordingly, the cup-shaped first housing part preferably has a circular or rectangular cross-section, and the second housing part and the bottom of the first housing part are preferably circular or rectangular in shape.

If the electrode-separator assembly is in the form of the winding with the two terminal end faces, the housing is preferably cylindrical.

If the housing is cylindrical, it generally comprises a cylindrical housing shell as well as a circular top part and a circular bottom part, whereby in this variant the first housing part comprises the housing shell and the circular bottom part while the second housing part corresponds to the circular top part. The circular top part and/or the circular bottom part can serve as contact elements, in particular as contact plates.

If the housing is prismatic, then the housing generally comprises several rectangular side walls as well as a polygonal, in particular rectangular top part and a polygonal, in particular rectangular bottom part, whereby in this variant the first housing part comprises the side walls and the polygonal bottom part while the second housing part corresponds to the circular polygonal top part. The top part and/or the bottom part can serve as contact elements, in particular as contact plates.

Both the first and the second housing part preferably consist of an electrically conductive material, in particular a metallic material. The housing parts can, for example, consist of a nickel-plated sheet steel or alloyed or unalloyed aluminum independently of one another.

In a further development of the first contacting variant, the cell has at least one of the immediately following features a. to e., in particular a combination of the immediately following features a. to e.:

a. The cell has a metallic contact element, in particular a metallic contact plate, with which the first longitudinal edge of the anode current collector is in direct contact, preferably longitudinally, and to which this longitudinal edge is connected by welding.

b. The cell has a metallic contact element, in particular a metallic contact plate, with which the first longitudinal edge of the cathode current collector is in direct contact, preferably longitudinally, and to which this longitudinal edge is connected by welding.

c. One of the contact elements, in particular one of the contact plates, is the bottom of the first housing part.

d. The other of the contact elements, in particular the other of the contact plates, is connected to the second housing part via an electrical conductor.

e. The cell comprises a seal that electrically isolates the first and second housing parts from each other.

In this embodiment, conventional housing parts can be used to enclose the electrode-separator assembly. No space is wasted for electrical conductors arranged between the bottom and the electrode-separator assembly. A separate contact element, in particular a separate contact plate, is not required on the bottom side. To close the housing, the electrically insulating seal can be drawn onto an edge of the second housing part. The assembly comprising the second housing part and the seal can be inserted into the opening of the first housing part and mechanically fixed there, for example by means of a crimping process.

In an embodiment of the first contacting variant, the second housing part can also serve as a contact element, in particular as a contact plate. In this embodiment, the cell has at least one of the immediately following features below, in particular a combination of the immediately preceding features a. to e.

a. The cell has a metallic contact element, in particular a metallic contact plate, with which the first longitudinal edge of the anode current collector is in direct contact, preferably longitudinally, and to which this longitudinal edge is connected by welding.

b. The cell has a metallic contact element, in particular a metallic contact plate, with which the first longitudinal edge of the cathode current collector is in direct contact, preferably longitudinally, and to which this longitudinal edge is connected by welding.

c. One of the contact elements, in particular one of the contact plates, is the bottom of the first housing part.

d. The other of the contact elements, in particular the other of the contact plates, is the second housing part.

e. The cell comprises an electrical seal that electrically isolates the first and second housing parts from each other.

In this embodiment, electrical conductors are not required on either side of the electrode-separator assembly to connect contact elements to housing parts. On one side, a contact element has the additional function of a housing part, and on the other side, a part of a housing serves as a contact element. The space inside the housing can be used optimally.

In a further preferred development of the first contacting variant, the cell is characterized by at least one of the immediately following features a. to e:

a. The cell has a metallic contact element, in particular a metallic contact plate, with which the first longitudinal edge of the anode current collector is in direct contact, preferably longitudinally, and to which this longitudinal edge is connected by welding.

b. The cell has a metallic contact element, in particular a metallic contact plate, with which the first longitudinal edge of the cathode current collector is in direct contact, preferably longitudinally, and to which this longitudinal edge is connected by welding.

c. One of the contact elements, in particular one of the contact plates, is the bottom of the first housing part.

d. The second housing part is welded into the opening of the first housing part and comprises a pole bushing, for example a pole stud surrounded by an electrical insulator, through which an electrical conductor is led out of the housing.

e. The other of the contact elements, in particular the other of the contact plates, is electrically connected to this electrical conductor.

It is preferred that the immediately preceding features a. to e. are realized in combination with each other.

In this embodiment, the housing parts are welded together and thus are electrically connected. For this reason, said pole bushing is required.

In a second preferred contacting variant, the cell has at least one of the immediately following features a. and b., and preferably a combination of the two features:

a. The housing comprises a tubular first housing part having two terminal openings, a second housing part closing one of the openings, and a third housing part closing the other of the openings.

b. The contact element, in particular the contact plate, is the second housing part or the third housing part.

In this contacting variant, too, the housing of the cell is preferably cylindrical or prismatic. The tubular first housing part has a circular or rectangular cross-section and the second and third housing parts are preferably circular or rectangular.

If the housing is cylindrical, the first housing part is generally hollow-cylindrical, while the second and third housing parts are circular and can serve as contact elements, in particular as contact plates, and at the same time as a bottom and lid, which can close the first housing part at its ends.

If the housing is prismatic, then the first housing part generally comprises a plurality of rectangular side walls connected to one another by common edges, while the second and third housing parts are each polygonal, in particular rectangular. Both the second and third housing parts can serve as contact elements, in particular as contact plates.

Both the first and the second housing part preferably consist of an electrically conductive material, in particular a metallic material. For example, the housing parts may consist of a nickel-plated steel sheet, stainless steel (for example of type 1.4303 or 1.4304), copper, nickel-plated copper or alloyed or unalloyed aluminum. It may also be preferred that housing parts electrically connected to the cathode consist of aluminum or an aluminum alloy, and housing parts electrically connected to the anode consist of copper or a copper alloy or nickel-plated copper.

A major advantage of this variant is that no cup-shaped housing parts are required to form the housing which have to be produced by upstream forming and/or casting operations. Instead, the tubular first housing part serves as the starting point.

In a preferred further development of the second variant, the cell has at least one of the immediately following features a. to e., in particular a combination of the immediately following features a. to e.:

a. The cell has a metallic contact element, in particular a metallic contact plate, with which the first longitudinal edge of the anode current collector is in direct contact, preferably longitudinally, and to which this longitudinal edge is connected by welding.

b. The cell has a metallic contact element, in particular a metallic contact plate, with which the first longitudinal edge of the cathode current collector is in direct contact, preferably longitudinally, and to which this longitudinal edge is connected by welding.

c. One of the contact elements, in particular one of the contact plates, is welded into one of the terminal openings of the first housing part and is the second housing part.

d. The third housing part is welded into the other of the terminal openings of the first housing part and comprises a pole bushing through which an electrical conductor is led out of the housing, for example a pole stud surrounded by an electrical insulator.

e. The other of the contact elements, in particular the other of the contact plates, is electrically connected to this electrical conductor.

It is preferred that the immediately preceding features a. to e. are realized in combination with each other.

In a further preferred development of the second variant, the cell has at least one of the immediately following features a. to d.:

a. The cell has a metallic contact element, in particular a metallic contact plate, with which the first longitudinal edge of the anode current collector is in direct contact, preferably longitudinally, and to which this longitudinal edge is connected by welding.

b. The cell has a metallic contact element, in particular a metallic contact plate, with which the first longitudinal edge of the cathode current collector is in direct contact, preferably longitudinally, and to which this longitudinal edge is connected by welding.

c. One of the contact elements, in particular one of the contact plates, is welded into one of the terminal openings of the first housing part and is the second housing part.

d. The other of the contact elements, in particular the other of the contact plates, closes the other of the terminal openings of the first housing part as a third housing part and is insulated from the first housing part by means of a seal.

It is preferred that the immediately preceding features a. to d. are realized in combination with each other.

Both embodiments are characterized by that on one housing side a contact element, in particular a contact plate, serves as a housing part and is connected to the first housing part by welding. On the other side, a contact element, in particular a contact plate, can also serve as a housing part. However, this must then be electrically insulated from the first housing part. Alternatively, a pole bushing can be used here as well.

The pole bushings of cells always comprise an electrical insulator which prevents electrical contact between the housing and the electrical conductor led out of the housing. The electrical insulator can be, for example, a glass or ceramic material or a plastic.

The electrode-separator assembly is preferably in the form of a cylindrical winding. Providing the electrodes in the form of such a winding allows particularly advantageous use of space in cylindrical housings. The housing is therefore in preferred embodiments also cylindrical.

In other preferred embodiments, the electrode-separator assembly is preferably in the form of a prismatic winding. Providing the electrodes in the form of such a winding allows particularly advantageous use of space in prismatic housings. The housing is therefore also prismatic in preferred embodiments.

In addition, prismatic housings can be filled particularly well by prismatic stacks of a plurality of electrode-separator assemblies. For this purpose, the electrode-separator assemblies can preferably have a substantially rectangular shape.

The housing parts are preferably sheet metal parts with a thickness in the range from 50 μm to 600 μm, preferably in the range from 150-350 μm. The sheet metal parts in turn preferably consist of alloyed or unalloyed aluminum, titanium, nickel or copper, optionally also stainless steel (for example of type 1.4303 or 1.4304) or nickel-plated steel.

It should be emphasized that all of the described embodiments in which a part of the housing serves as the contact element, in particular as the contact plate, and/or the contact element, in particular the contact plate, forms a part of the housing that encloses the electrode-separator assembly, in particular the first and second contacting variants, can also be realized completely independently of the at least one inorganic material that improves its resistance to thermal stress. The disclosure thus also comprises cells in which a part of the housing serves as the contact element, in particular as the contact plate, and/or the contact element, in particular the contact plate, forms a part of the housing, but the separator does not necessarily have to comprise the at least one inorganic material that improves its resistance to thermal stress.

### Preferred Embodiments of the Current Collectors.

In preferred embodiments, the cell is characterized by at least one of the immediately following features a. to c.:

a. the strip-shaped main region of the current collector connected to the contact element, in particular the contact plate, by welding, preferably the strip-shaped main region of the current collector connected to the contact plate by welding, has a plurality of apertures.

b. The apertures in the main region are round or square holes, especially punched or drilled holes.

c. The current collector connected to the contact element, in particular the contact plate, by welding is perforated in the main region, in particular by round hole or slotted hole perforation.

The plurality of apertures results in a reduced volume and also in a reduced weight of the current collector. This makes it possible to introduce more active material into the cell and thus drastically increase the energy density of the cell. Energy density increases up to the double-digit percentage range can be achieved in this way.

In some preferred embodiments, the apertures are introduced into the strip-shaped main region by laser.

In principle, the geometry of the apertures is not essential. What is important is that as a result of the insertion of the apertures, the mass of the current collector is reduced and there is more space for active material, since the apertures can be filled with the active material.

On the other hand, it can be very advantageous to ensure that the maximum diameter of the apertures is not too large when producing them. Preferably, the apertures should not be more than twice the thickness of the layer of electrode material on the respective current collector.

In preferred embodiments, the cell is characterized by the immediately following feature a. below:

a. The apertures in the current collector, especially in the main region, have diameters in the range of 1 μm to 3000 μm.

Within this preferred range, diameters in the range from 10 μm to 2000 μm, preferably from 10 μm to 1000 μm, especially from 50 μm to 250 μm, are preferred.

Particularly preferably, the cell has at least one of the immediately following features a. and b:

a. The current collector which is connected to the contact element, in particular the contact plate, by welding, has, at least in a partial section of the main region, a lower weight per unit area than in the free edge strip of the same current collector.

b. The current collector which is connected to the contact element, in particular the contact plate, by welding, has no or fewer apertures per unit area in the free edge strip than in the main region.

It is preferred that the immediately preceding features a. and b. are realized in combination with each other.

The free edge strips of the anode and cathode current collector bound the main region towards the first edges or the first longitudinal edges. Preferably, both the anode and cathode current collectors comprise free edge strips along both of their edges, in particular along both of their longitudinal edges.

The apertures characterize the main region. In other words, the boundary between the main region and the free edge strip corresponds to a transition between regions with and without apertures.

The apertures are preferably distributed substantially evenly over the main region.

In further preferred embodiments, the cell has at least one of the immediately following features below a. to c.:

a. The weight per unit area of the current collector in the main region is reduced by 5% to 80% compared to the weight per unit area of the current collector in the free edge strip.

b. The current collector has in the main region a hole area in the range of 5% to 80%.

c. The current collector has a tensile strength of 20 N/mm2 to 250 N/mm2 in the main region.

The hole area, often referred to as the free cross-section, can be determined according to ISO 7806-1983. The tensile strength of the current collector in the main region is reduced compared to current collectors without the apertures. Its determination can be done according to DIN EN ISO 527 part 3.

It is preferred that the anode current collector and the cathode current collector are identical or similar in terms of apertures. The respective achievable energy density improvements add up. In preferred embodiments, the cell therefore has at least one of the immediately following features a. to c.:

a. The anode current collector main region and the cathode current collector main region, preferably the strip-shaped anode current collector main region and the strip-shaped cathode current collector main region, are both characterized by a plurality of the apertures.

b. The cell comprises the contact element, in particular the contact plate, which rests on one of the first edges or longitudinal edges, as a first contact element or contact plate, and further comprises a second contact element, in particular a second metallic contact plate, which rests on the other of the first edges or longitudinal edges.

c. The second contact element, in particular the second contact plate, is connected to this other longitudinal edge by welding.

It is preferred that the immediately preceding features a. to c. are realized in combination with each other. Features b. and c. can, however, also be implemented in combination without feature a.

The preferred embodiments of the current collector provided with the apertures described above are independently applicable to the anode current collector and the cathode current collector.

The use of perforated current collectors or those otherwise provided with a plurality of apertures has not yet been seriously considered for lithium-ion cells, since it is very difficult to contact such current collectors electrically. As mentioned at the outset, the electrical connection of the current collectors is often realized via separate electrical conductor tabs. However, reliable welding of these conductor tabs to perforated current collectors in industrial mass production processes is difficult to realize without an acceptable error rate.

According to the disclosure, this problem is solved by welding the current collector edges to the contact elements, in particular the contact plates, as described. The concept according to the disclosure makes it possible to completely dispense with separate conductor tabs, thus enabling the use of current collectors with a low material content and provided with apertures. In particular, in embodiments in which the free edge strips of the current collectors are not provided with apertures, welding can be performed reliably with exceptionally low reject rates.

This is particularly true if the edges of the current collectors, especially the longitudinal edges of the current collectors, are provided with the support layer described above and the separator is improved against thermal stress as described.

It should be emphasized that all the described embodiments, in which the preferably strip-shaped main region of the current collector, which is connected to the contact element, in particular to the contact plate, by welding, has a plurality of apertures, can also be realized completely independently of the separator comprising at least one inorganic material that improves its resistance to thermal stress. The disclosure thus also comprises cells in which the preferably strip-shaped main region of the current collector connected to the contact element, in particular the contact plate, by welding, has a plurality of apertures, but the separator does not necessarily have to comprise the at least one inorganic material that improves its resistance to thermal stress.

### Other Preferred Embodiments of the Cell

The lithium-ion cell may be a button cell. Button cells are cylindrical in shape and have a height that is less than their diameter. Preferably, the height is in the range of 4 mm to 15 mm. It is further preferred that the button cell has a diameter in the range from 5 mm to 25 mm. Button cells are suitable, for example, for supplying electrical energy to small electronic devices such as watches, hearing aids and wireless headphones.

The nominal capacity of a lithium-ion cell in the form of a button cell is generally up to 1500 mAh. Preferably, the nominal capacity is in the range from 100 mAh to 1000 mAh, preferably in the range from 100 to 800 mAh.

The lithium-ion cell may be a cylindrical round cell. Cylindrical round cells have a height that is greater than their diameter. They are particularly suitable for applications in the automotive sector, for e-bikes or also for other applications with high energy requirements.

Preferably, the height of lithium-ion cells designed as round cells is in the range from 15 mm to 150 mm. The diameter of the cylindrical round cells is preferably in the range of 10 mm to 60 mm. Within these ranges, form factors of, for example, 18×65 (diameter*height in mm) or 21×70 (diameter*height in mm) are preferred. Cylindrical round cells with these form factors are particularly suitable for supplying power to electric drives in motor vehicles.

The nominal capacity of the lithium-ion cell, which is designed as a cylindrical round cell, is preferably up to 90000 mAh. With the form factor of 21×70, the cell in one embodiment as a lithium-ion cell preferably has a nominal capacity in the range from 1500 mAh to 7000 mAh, preferably in the range from 3000 to 5500 mAh. With the form factor of 18×65, the cell in one embodiment as a lithium-ion cell preferably has a nominal capacity in the range of 1000 mAh to 5000 mAh, preferably in the range of 2000 to 4000 mAh.

In the European Union, manufacturers are strictly regulated in providing information on the nominal capacities of secondary batteries. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard, and information on the nominal capacity of secondary lead-acid batteries must be based on measurements according to the IEC/EN 61056-1 standard. Any information on nominal capacities in the present application is preferably also based on these standards.

In embodiments in which the cell is a cylindrical round cell, the anode current collector, the cathode current collector and the separator are preferably ribbon-shaped and preferably have the following dimensions:
A length in the range from 0.5 m to 25 m
A width in the range 30 mm to 145 mm

In these cases, the free edge strip extending along the first longitudinal edge, which is not loaded with the electrode material, preferably has a width of no more than 5000 μm.

In the case of a cylindrical round cell with the form factor 18×65, the current collectors preferably have
a width of 56 mm to 62 mm, preferably 60 mm, and
a length of not more than 1.5 m.

In the case of a cylindrical round cell with the form factor 21×70, the current collectors preferably have
a width of 56 mm to 68 mm, preferably 65 mm, and
a length of not more than 2.5 m.

The function of a lithium-ion cell is based on the availability of sufficient mobile lithium ions (mobile lithium) to balance the drawn off electric current by migration between the anode and the cathode or the negative electrode and the positive electrode. By mobile lithium in the context of this application is to be understood that the lithium is available for storage and release processes in the electrodes in the course of the discharge and charge processes of the lithium-ion cell or can be activated for this purpose. In the course of the discharge and charge processes of a lithium-ion cell, losses of mobile lithium occur over time. These losses occur as a result of various, generally unavoidable side reactions. Losses of mobile lithium already occur during the first charge and discharge cycle of a lithium-ion cell. During this first charge and discharge cycle, a top layer generally forms on the surface of the electrochemically active components on the negative electrode. This top layer is called the Solid Electrolyte Interphase (SEI) and generally consists of mainly electrolyte decomposition products as well as a certain amount of lithium, which is firmly bound in this layer.

The loss of mobile lithium associated with this process is particularly severe in cells whose anode has portions of silicon. In order to compensate for these losses, the cell in preferred embodiments has at least one of the immediately following features a. and b.:

a. The cell comprises a depot of lithium or a lithium-containing material not comprised by the positive and/or negative electrode, which can be used to compensate for losses of mobile lithium in the cell during its operation.

b. The depot is in contact with the electrolyte of the cell.

c. The cell has an electrical conductor and, if necessary, also a controllable switch via which the depot can be electrically connected to the positive or negative electrode.

It is preferred that the immediately preceding features a. to c. are realized in combination with each other.

Particularly preferably, the depot is arranged inside the housing of the cell and the electrical conductor is led out of the housing, for example via a suitable pole bushing, in particular up to an electrical contact which can be drawn off from outside the housing.

The electrically contactable lithium depot enables lithium to be supplied to the electrodes of the cell as required or excess lithium to be removed from the electrodes to prevent lithium plating. For this purpose, the lithium depot can be connected via the electrical conductor against the negative or against the positive electrode of the lithium-ion cell. Excess lithium can be fed to the lithium depot and deposited there if required. For these applications, means can be provided that allow separate monitoring of the individual potentials of the anode and cathode in the cell and/or external monitoring of the cell balance via electrochemical analyses such as DVA (differential voltage analysis).

The electrical conductor and the associated lithium depot must be electrically insulated from the positive and negative electrodes and any electrically coupled components of the cell.

The lithium or lithium-containing material of the lithium depot may be, for example, metallic lithium, a lithium metal oxide, a lithium metal phosphate, or other materials familiar to the skilled person.

### Prismatic Embodiment

The present disclosure also comprises energy storage elements comprising a stack of multiple anodes and multiple cathodes enclosed in a prismatic housing.

In particular, therefore, the disclosure also comprises an energy storage element having the immediately following features a. to k.:

a. It comprises a plurality of anodes and cathodes,

b. the anodes each comprise an anode current collector and a negative electrode material,

c. the anode current collectors each have a main region loaded with a layer of the negative electrode material, and a free edge strip extending along an edge of the anode current collector that is not loaded with the negative electrode material,

d. the cathodes each comprise a cathode current collector and a positive electrode material,

e. the cathode current collectors each have a main region loaded with a layer of the positive electrode material, and a free edge strip extending along an edge of the cathode current collector that is not loaded with the positive electrode material,

f. the anodes and cathodes are stacked, wherein the anodes and cathodes in the stack are separated by separators,

g. the stack is enclosed in a prismatic housing,

h. the free edge strips of the anode current collectors protrude from one side of the stack and the free edge strips of the cathode current collectors protrude from another side of the stack,

i. the energy storage element has a contact element which is in direct contact with the free edge strips of the anode current collectors and/or the cathode current collectors, and

j. the contact element is connected to this edge strip by welding,

as well as the additional characterizing feature

k. the separator comprises at least one inorganic material that improves its resistance to thermal stress.

With regard to the layer of the negative electrode material, the layer of the positive electrode material and the current collectors the same preferred developments apply as in the case of the lithium-ion cell. The same applies to the electrolyte, if the energy storage element has one, and in particular also to the separators and the at least one inorganic material.

Preferably, the energy storage element is characterized by at least one of the following additional features:

a. The separators comprise the at least one inorganic material only in regions.

b. The separators each have an edge strip in which they comprise the at least one inorganic material as a coating and/or as a particulate filler material.

c. The separators have a main region in which they are free of the at least one inorganic material.

Particularly preferably, the energy storage element comprises two contact elements, one of which is in direct contact with the free edge strip of the anode current collector and the other of which is in direct contact with the free edge strip of the cathode current collector, the contact elements and the edges in contact therewith each being connected by welding or soldering.

In the manufacture of conventional electrode stacks consisting of several cells, care is taken to ensure that arresters connected to current collectors with opposite polarity cannot protrude from each other in order to avoid the risk of a short circuit. Since, the free edge strips of the anode current collectors protrude from one side of the stack and the free edge strips of the cathode current collectors protrude from another side of the stack, the risk of a short circuit as a result of direct contact of oppositely poled current collectors is normally not present in the energy storage element.

The contact elements serve as a central conductor for the currents drawn from the electrodes during operation of the energy storage element. Here, the free edge strips of the anode current collectors and the cathode current collectors can ideally be connected to the contact elements over their entire length. Such electrical contacting significantly reduces the internal resistance within the energy storage element. The arrangement described can thus absorb the occurrence of large currents very well. With minimized internal resistance, thermal losses at high currents are reduced. In addition, the dissipation of thermal energy from the assembly is favored. Under heavy loads, heating is thus not localized but uniformly distributed.

In some preferred embodiments, the energy storage element has at least one of the immediately following features a. and b.:

a. Metal sheets with a thickness in the range of 50 μm to 600 μm, preferably 150-350 μm, are used as contact elements.

b. The contact elements, in particular the metal sheets, consist of alloyed or unalloyed aluminum, titanium, nickel or copper, or of stainless steel (for example type 1.4303 or 1.4304) or of nickel-plated steel.

Preferably, the immediately aforementioned features a. and b. are realized in combination with each other.

The shape and dimension of the contact elements, in particular the metal sheets, are preferably adapted to the shape and dimension of the sides of the assembly from which the free edge strips of the current collectors. In preferred embodiments, the contact elements are rectangular in shape. They can thus also be easily integrated into a housing with a prismatic basic shape.

In preferred embodiments, the energy storage element is characterized by at least one of the following features:

a. It comprises at least one contact element having an L-shaped profile.

b. It comprises at least one contact element having a U-shaped profile.

c. The contact element has an angled mounting extension.

Preferably, the immediately aforementioned features a. and c. or b. and c. are combined.

If the contact element with L-shaped profile is used, protruding edge strips of the respective current collectors can be contacted on two sides of the assembly. For this purpose, of course, it is first necessary that the electrodes of the assembly comprise two edges at which their current collectors have a free edge area that is accessible to welding or soldering.

In the case of a U-shaped profile of the contact element, it is generally provided that the contacting of the protruding edges of the respective current collectors takes place on three sides of the assembly. The angled fastening extension, if provided, is primarily intended for fastening the contact element to the housing of the energy storage element, provided that the contact element is not itself part of the housing. Furthermore, the fastening extension can also be part of an L-shaped or U-shaped profile and can also be used, for example, for attaching a pole stud.

The more sides of the assembly are provided with contact elements, the better are the heat dissipation properties of the energy storage element.

The prismatic housing of the energy storage element preferably encloses the assembly in a gas-tight and/or liquid-tight manner. It is preferably formed from two or more metallic housing parts, for example as described in EP 3117471 B1. The housing parts can be assembled, for example, by welding.

The housing preferably comprises several rectangular side walls as well as a polygonal, in particular rectangular bottom and a polygonal, in particular rectangular top part. In particular, the top part and the bottom can also serve as contact elements, preferably as contact plates.

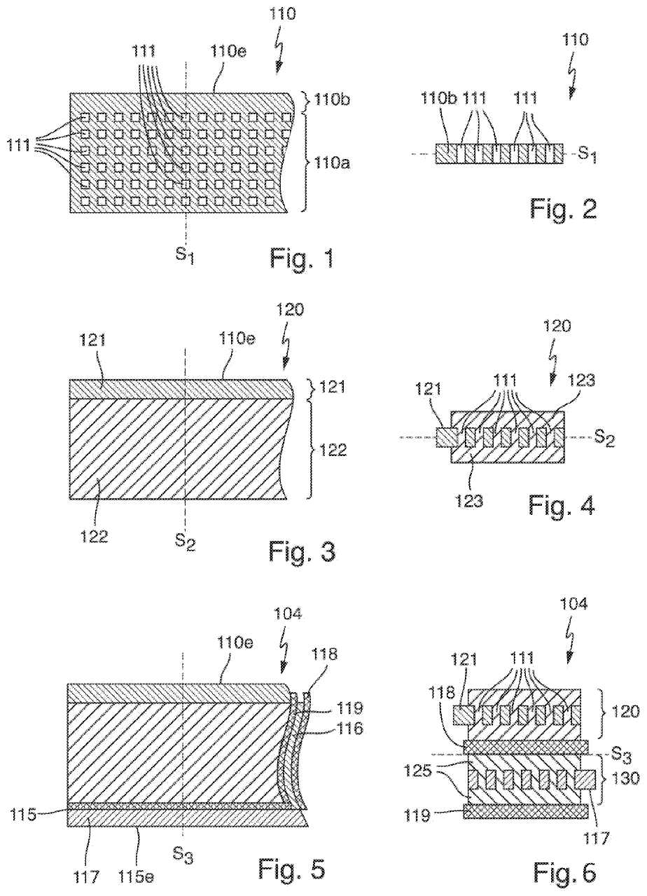

FIG. 1 and FIG. 2 illustrate the design of a current collector 110 that can be used in a cell. FIG. 2 is a sectional view along S1. The current collector 110 comprises a plurality of apertures 111, which are rectangular holes. The region 110a is characterized by the apertures 111, whereas no apertures are found in the region 110b along the longitudinal edge 110e. Therefore, the current collector 110 has a significantly lower weight per unit area in the area 110a than in the area 110b.

FIG. 3 and FIG. 4 illustrate an anode 120 fabricated by applying a negative electrode material 123 to both sides of the current collector 110 shown in FIG. 2 and FIG. 3. FIG. 4 is a sectional view along S2. The current collector 110 now has a strip-shaped main region 122 loaded with a layer of the negative electrode material 123, and a free edge strip 121 extending along the longitudinal edge 110e which is not loaded with the electrode material 123. Furthermore, the electrode material 123 also fills the apertures 111.

FIG. 5 and FIG. 6 illustrate an electrode-separator assembly 104 fabricated using the anode 120 shown in FIG. 3 and FIG. 4. In addition, it comprises the cathode 115 and the separators 118 and 119. FIG. 6 is a sectional view along S3. The cathode 115 builds on the same current collector design as the anode 120. Preferably, the current collectors 110 and 115 of anode 120 and cathode 130 differ only in their respective material choices. For example, the current collector 115 of cathode 130 comprises a strip-shaped main region 116 loaded with a layer of positive electrode material 125, and a free edge strip 117 extending along longitudinal edge 115e that is not loaded with electrode material 125. By spirally winding, the electrode-separator assembly 104 can be transformed into a winding such as may be included in the cell.

In some preferred embodiments, the free edge strips 117 and 121 are coated on both sides and at least in some areas with an electrically insulating support material, for example a ceramic material such as silicon oxide or aluminum oxide.

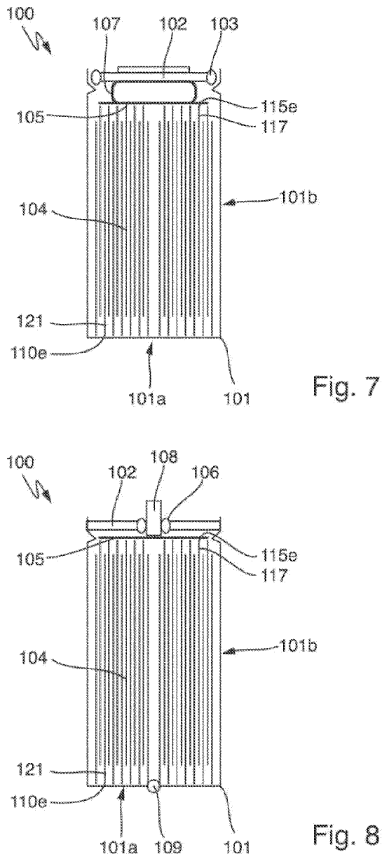

FIG. 7 illustrates a cell 100 having a housing comprising a first housing part 101 and a second housing part 102. Enclosed within the housing is the electrode-separator assembly 104. The housing is generally cylindrical in shape, and the housing part 101 has a circular bottom 101a, a hollow cylindrical shell 101b, and a circular opening opposite the bottom 101a. The housing part 102 serves to close the circular opening and is formed as a circular lid. The electrode-separator assembly 104 is in the form of a cylindrical winding having two terminal end faces.

In the case of prismatic embodiments, a section through an energy storage element could look exactly the same. In this case, the housing part 101 would have a rectangular bottom 101a, a rectangular side wall 101b and a rectangular cross-section, and a rectangular opening, and the housing part 102 would be formed as a rectangular lid to close the rectangular opening. And the reference number 104 in this case would not denote an electrode-separator assembly in a cylindrical shape but a stack of a plurality of identical electrode-separator assemblies.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the contact plate 105 over its entire length and is connected thereto by welding over at least several sections, preferably over its entire length.

The contact plate 105 is in turn electrically connected to the housing part 102 via the electrical conductor 107. Preferably, there is a welded connection between the conductor 107 and the contact plate 105 on one side and the conductor 107 and the housing part 102 on the other side, respectively.

For an improved overview, no other components of the electrode-separator assembly 104 (especially separators and electrode materials) are shown—apart from the current collectors 110 and 115.

The housing parts 101 and 102 are electrically insulated from each other by the seal 103. The housing is closed, for example, by flanging. The housing part 101 forms the negative pole and the housing part 102 the positive pole of the cell 100.

FIG. 8 illustrates a cell 100 having a housing comprising a first housing part 101 and a second housing part 102. Enclosed within the housing is the electrode-separator assembly 104. The housing is generally cylindrical in shape, and the housing part 101 has a circular bottom 101a, a hollow cylindrical shell 101b, and a circular opening opposite the bottom 101a. The housing part 102 serves to close the circular opening and is formed as a circular lid. The electrode-separator assembly 104 is in the form of a cylindrical winding having two terminal end faces.

In the case of prismatic embodiments, a section through an energy storage element could look exactly the same. In this case, the housing part 101 would have a rectangular bottom 101a, a rectangular side wall 101b and a rectangular cross-section, and a rectangular opening, and the housing part 102 would be formed as a rectangular lid to close the rectangular opening. And the reference number 104 in this case would not denote an electrode-separator assembly in a cylindrical shape but a stack of a plurality of identical electrode-separator assemblies.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the contact plate 105 over its entire length and is connected thereto by welding over at least several sections, preferably over its entire length.

The contact plate 105 is directly connected, preferably welded, to the metallic pole stud 108. The pole stud is led out of the housing through an aperture in the housing part 102 and insulated from the housing part 102 by means of the electrical insulation 106. The pole stud 108 and the electrical insulation 106 together form a pole bushing.

For an improved overview, no other components of the electrode-separator assembly 104 (in particular separators and electrode materials) are shown here either—apart from the current collectors 110 and 115.

In the bottom 101a there is a hole 109 which is closed, for example, by means of soldering, welding or bonding, and which can be used, for example, to introduce electrolyte into the housing. Alternatively, a hole could have been made in the housing part 102 for the same purpose.

The housing part 102 is welded into the circular opening of the housing part 101. The housing parts 101 and 102 thus have the same polarity and form the negative pole of the cell 100. The pole stud 108 forms the positive pole of the cell 100.

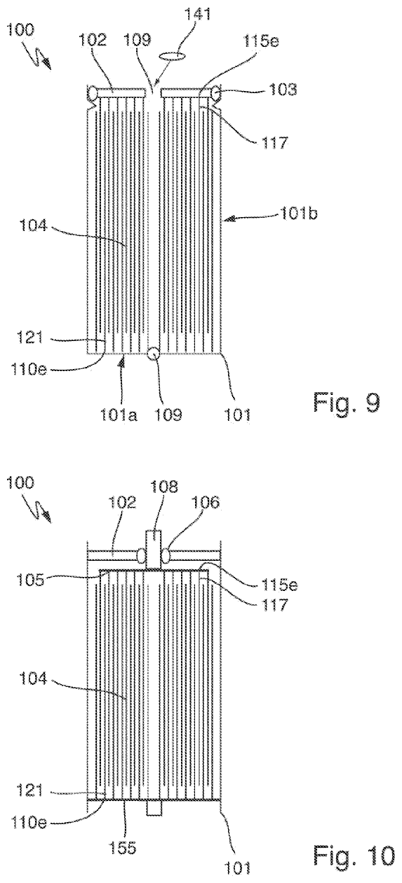

FIG. 9 illustrates a cell 100 having a housing comprising a first housing part 101 and a second housing part 102. Enclosed within the housing is the electrode-separator assembly 104. The housing is generally cylindrical in shape, and the housing part 101 has a circular bottom 101a, a hollow cylindrical shell 101b, and a circular opening opposite the bottom 101a. The housing part 102 serves to close the circular opening and is formed as a circular lid. The electrode-separator assembly 104 is in the form of a cylindrical winding having two terminal end faces.

In the case of prismatic embodiments, a section through an energy storage element could look exactly the same. In this case, the housing part 101 would have a rectangular bottom 101a, a rectangular side wall 101b and a rectangular cross-section, and a rectangular opening, and the housing part 102 would be formed as a rectangular lid to close the rectangular opening. And the reference number 104 in this case would not denote an electrode-separator assembly in a cylindrical shape but a stack of a plurality of identical electrode-separator assemblies.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the housing part 102 over its entire length and is connected thereto by welding over at least several sections, preferably over its entire length.

For an improved overview, no other components of the electrode-separator assembly 104 (in particular separators and electrode materials) are shown here either—apart from the current collectors 110 and 115.

A hole 109 which is closed, for example by means of soldering, welding or bonding, is found in the bottom 101a, which can serve, for example, to introduce electrolyte into the housing. Another hole 109, which can serve the same purpose, is found here in the housing part 102. Preferably, this is closed by the pressure relief valve 141, which can be welded onto the housing part 102, for example.

The holes 109 shown are generally not both needed. In many cases, therefore, the cell 100 shown in FIG. 9 has only one of the two holes.

The housing parts 101 and 102 are electrically insulated from each other by the seal 103. The housing is closed, for example, by flanging. The housing part 101 forms the negative pole and the housing part 102 the positive pole of the cell 100.

FIG. 10 illustrates a cell 100 having a housing comprising a first housing part 101 and a second housing part 102 and a third housing part 155. The electrode-separator assembly 104 is enclosed in the housing. The housing has an overall cylindrical shape, the housing part 101 being formed here as a hollow cylinder with two end face circular openings. The housing parts 102 and 155 serve to close the circular openings and are formed as circular lids. The electrode-separator assembly 104 is in the form of a cylindrical winding with two terminal end faces.

In the case of prismatic embodiments, a section through an energy storage element could look exactly the same. In this case, the housing part 101 would have a rectangular cross-section and two rectangular openings, and the housing parts 102 and 155 would be rectangular lids to close the rectangular openings. And the reference number 104 in this case would not denote an electrode-separator assembly in cylindrical form but a stack of several identical electrode-separator assemblies.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the housing part 155 over its entire length and is connected thereto by welding over at least several sections, preferably over its entire length. The housing part 155 thus functions as a contact plate. The edge 115e of the cathode current collector 115 is in direct contact with the contact plate 105 over its entire length and is connected thereto by welding over at least several sections, preferably over its entire length.

For an improved overview, no other components of the electrode-separator assembly 104 (in particular separators and electrode materials) are shown here either—apart from the current collectors 110 and 115.

The contact plate 105 is directly connected, preferably welded, to the metallic pole stud 108. The pole stud is led out of the housing through an aperture in the housing part 102 and insulated from the housing part 102 by means of the electrical insulation 106. The pole stud 108 and the electrical insulation 106 together form a pole bushing.

In the housing part 102 there is a hole 109 which is closed, for example, by means of soldering, welding or bonding, and which can be used, for example, to introduce electrolyte into the housing. Alternatively, a hole could have been made in the housing part 155 for the same purpose.

The housing parts 102 and 155 are welded into the circular openings of the housing part 101. The housing parts 101, 102 and 155 thus have the same polarity and form the negative pole of the cell 100. The pole stud 108 forms the positive pole of the cell 100.

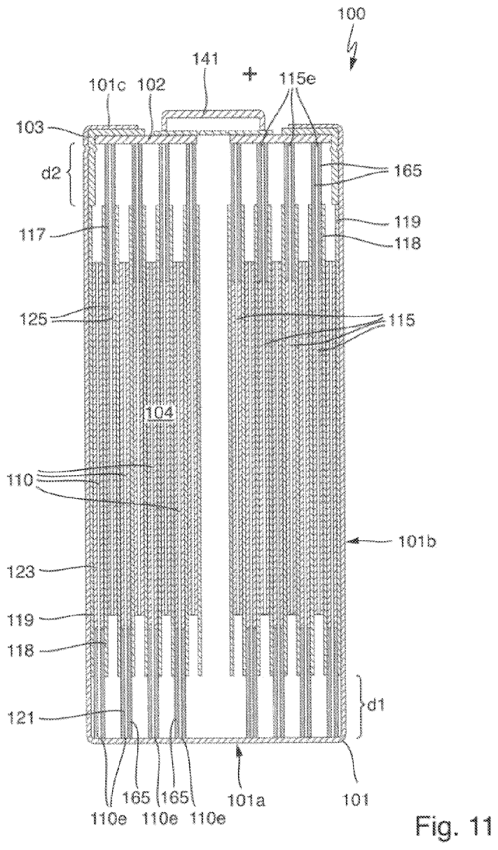

FIG. 11 illustrates a cell 100 having a housing comprising a first housing part 101 and a second housing part 102. Enclosed within the housing is the electrode-separator assembly 104. The housing is generally cylindrical in shape, and the housing part 101 has a circular bottom 101a, a hollow cylindrical shell 101b, and a circular opening opposite the bottom 101a. The housing part 102 serves to close the circular opening and is formed as a circular lid. The electrode-separator assembly 104 is in the form of a cylindrical winding having two terminal end faces.

In the case of prismatic embodiments, a section through an energy storage element could look exactly the same. In this case, the housing part 101 would have a rectangular bottom 101a, a rectangular side wall 101b and a rectangular cross-section, and a rectangular opening, and the housing part 102 would be formed as a rectangular lid to close the rectangular opening. And the reference number 104 in this case would not denote an electrode-separator assembly in a cylindrical shape but a stack of a plurality of identical electrode-separator assemblies.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length.

The edge 115e of the cathode current collector 115 is in direct contact with the housing part 102 over its entire length and is connected thereto by welding over at least several sections, preferably over its entire length. The housing part 102 thus serves here simultaneously as a contact plate.

The anode current collector 110 is loaded on both sides with a layer of negative electrode material 123, but has a free edge strip 121 extending along the longitudinal edge 110e that is not loaded with the electrode material 123. Instead, the free edge strip 121 is coated on both sides with a ceramic support material 165.

The cathode current collector 115 is loaded on both sides with a layer of negative electrode material 125, but has a free edge strip 117 extending along the longitudinal edge 115e that is not loaded with the electrode material 125. Instead, the free edge strip 117 is coated on both sides with a ceramic support material 165.

In preferred embodiments, the current collectors 110 and 115 may be perforated in the areas where they are loaded with the electrode materials 123 and 125, for example as shown in FIG. 1 and FIG. 2.

The electrode-separator assembly 104 has two end faces formed by the longitudinal edges 118a and 119a and 118b and 119b of the separators 118 and 119. The longitudinal edges of the current collectors 110 and 115 protrude from these end faces. The corresponding protrusions are labeled d1 and d2.

Separators 118 and 119 each either have at least one surface that includes a ceramic coating, or each comprises a ceramic filler material that improves their resistance to thermal stress.

A hole 109 is found in the housing part 102, which can be used, for example, to introduce electrolyte into the housing. The hole is closed by the pressure relief valve 141, which is connected to the housing part 102, for example, by welding.

The housing parts 101 and 102 are electrically insulated from each other by the seal 103. The housing is closed by flanging. For this purpose, the opening edge 101c of the housing part is bent radially inwards. The housing part 101 forms the negative pole and the housing part 102 the positive pole of the cell 100.

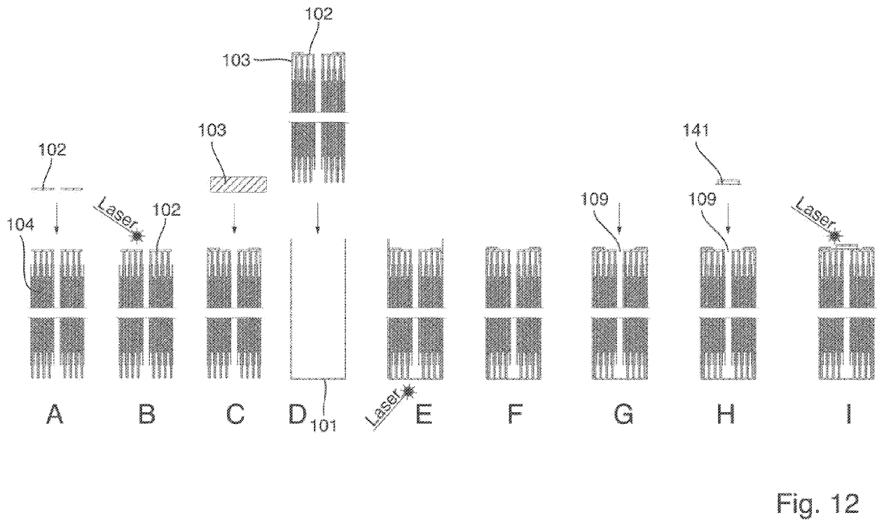

The cell shown in FIG. 11 can be manufactured according to FIG. 12, and the individual process steps A to I are described below. First, the electrode-separator assembly 104 is provided, on the upper end face of which the housing part 102 serving as contact plate is placed. This is welded in step B to the longitudinal edge 115e of the cathode current collector 115. In step C, the circumferential seal 103 is applied to the edge of the housing part 102. With this, in step D, the electrode-separator assembly 104 is inserted into the housing part 101 until the longitudinal edge 110e of the anode current collector 110 is in direct contact with the bottom 101a of the housing part 101. In step E, this is welded to the bottom 101a of the housing part 101. In step F, the housing is closed by flanging. For this purpose, the opening edge 101c of the housing part 101 is bent radially inwards. In step G, the housing is filled with electrolyte, which is metered into the housing through the opening 109. The opening 109 is closed in steps H and I by means of the pressure relief valve 141, which is welded onto the housing part 102.

For example, the electrode-separator assembly 104 may comprise a positive electrode of 95 wt % NMCA, 2 wt % of an electrode binder, and 3 wt % carbon black as a conductive agent.

In some preferred embodiments, the negative electrode may comprise, for example, 70 wt % silicon, 25 wt % graphite, 2 wt % of an electrode binder, and 3 wt % carbon black as a conductive agent. The electrolyte can be a 2 M solution of LiPF₆ in THF/mTHF (1:1) or a 1.5 M solution of LiPF₆ in FEC/EMC (3:7) with 2 wt % VC.

In many other preferred embodiments, anodes are used which have a high proportion of a carbon-based storage material and a silicon/silicon oxide content <10 wt. %. In these cases, classical electrolytes are often used in which a conducting salt is dissolved in a mixture of organic carbonates.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A lithium-ion cell, comprising:
a ribbon-shaped electrode-separator assembly comprising an anode, a cathode, and a separator in a sequence anode/separator/cathode, the electrode-separator assembly being in the form of a winding with two terminal end faces, wherein:
the anode comprises a negative electrode material and a ribbon-shaped anode current collector having a first longitudinal edge, a second longitudinal edge, and two ends, wherein a strip-shaped main region of the anode current collector is loaded with a layer of the negative electrode material and a free edge strip of the anode current collector, extending along the first longitudinal edge, is not loaded with the negative electrode material,
the cathode comprises a positive electrode material and a ribbon-shaped cathode current collector having a first longitudinal edge, a second longitudinal edge, and two ends, wherein a strip-shaped main region of the cathode current collector is loaded with a layer of the positive electrode material and a free edge strip of the cathode current collector, extending along the first longitudinal edge, is not loaded with the positive electrode material, and
the separator comprises at least one inorganic material that improves its resistance to thermal stress;
a housing enclosing the electrode-separator assembly; and
a metallic contact element,
wherein the anode and the cathode are offset within the electrode-separator assembly so that the first longitudinal edge of the anode current collector protrudes from a first terminal end face of the terminal faces and the first longitudinal edge of the cathode current collector protrudes from a second terminal end face of the terminal faces,
wherein a respective first longitudinal edge is in direct contact with the metallic contact element, the respective first longitudinal edge being the first longitudinal edge of the anode current collector or the first longitudinal edge of the cathode current collector, and
wherein the metallic contact element is connected to the respective first longitudinal edge by a weld.

2. The cell according to claim 1, wherein:
the electrode-separator assembly additionally comprises a second separator,
wherein the second separator and the separator are identical, and
wherein the electrode-separator assembly has a sequence anode/separator/cathode/second separator or the sequence second separator/anode/separator/cathode.

3. The cell according to claim 1, wherein:
the separator is a ribbon-shaped plastic substrate with first and second longitudinal edges and two ends, the ribbon-shaped plastic substrate having a thickness in a range of 5 μm to 50 μm, and
the first and second longitudinal edges of the separator form the end faces of the electrode-separator assembly.

4. The cell according to claim 1, wherein the at least one inorganic material is contained in the separator as particulate filler material.

5. The cell according to claim 1, wherein the at least one inorganic material is present as a coating on a surface of the separator.

6. The cell according to claim 1, wherein at least one of the following additional features is present:
the at least one inorganic material is or comprises an electrically insulating material,
the at least one inorganic material is or comprises at least one material selected from the group consisting of ceramic material, glass-ceramic material, and glass,
the at least one inorganic material is or comprises a lithium ion conducting ceramic material,
the at least one inorganic material is or comprises an oxidic material, and/or
the ceramic or oxide material is aluminum oxide (Al2O3), titanium oxide (TiO2), titanium nitride (TiN), titanium aluminum nitride (TiAlN), a silicon oxide, or titanium carbonitride (TiCN).

7. The cell according to claim 1, wherein at least one of the following additional features is present:
the separator comprises the at least one inorganic material only in regions,
the separator has an edge strip along a first and/or the second longitudinal edge of the separator in which the separator comprises the at least one inorganic material as a coating and/or as a particulate filler material, and/or
the separator has a ribbon-shaped main region in which it is free of the at least one inorganic material.

8. The cell according to claim 1, wherein the free edge strip of the anode current collector and/or the free edge strip of the cathode current collector are/is coated with a support material different from both the negative electrode material and the positive electrode material.

9. The cell of claim 8, wherein at least one of the following additional features is present:
the free edge strip of the anode current collector and/or the free edge strip of the cathode current collector comprises a first region and a second region, wherein the first region is coated with the support material while the second region is uncoated,
the first sub-region and the second sub-region each have a shape of a line or a strip and run parallel to each other, and/or
the first sub-region is disposed between the strip-shaped main region of the anode current collector or the cathode current collector and the second sub-region.

10. The cell according to claim 8, wherein the free edge strip of the anode current collector is coated with the support material up to the first longitudinal edge thereof and/or the free edge strip of the cathode current collector is coated with the support material up to the first longitudinal edge thereof.

11. The cell according to claim 8, having wherein at least one of the following additional features is present:
the separator comprises the at least one inorganic material only in regions, and/or
the separator comprises the at least one inorganic material in a region that covers a boundary between the support material and the respective adjacent electrode material in the electrode-separator assembly.
